(19) United States
(12) Patent Application Publication
(10) Pub. No.: US 2005/0162696 A1
(43) Pub. Date: Jul. 28, 2005

(54) Print auditing network

(76) Inventors: Janine Louise Helms, Meridian, ID (US); Garth Frederick Schmeling, Boise, ID (US); Daniel James Dyer, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/764,779

(22) Filed: Jan. 26, 2004

(51) Int. Cl. G06F 15/00

(52) U.S. Cl. 358/1.18; 358/1.15

(57) ABSTRACT

Various system, methods, and programs embodied in a computer-readable medium are provided for the auditing of print jobs in a network. In one representative embodiment, the network includes a client that originates a print job for printing and a printer in data communication with the client that it employed to print the print job. In addition, a print job aggregator is in data communication with the client and the printer. The client originates a print job for printing and the print job includes parametric data associated with the print job. A client agent is executed in the client to provide a first report of the parametric data associated with the print job to the print job aggregator before the print job is transmitted to the printer. A printer agent is executed in the printer to provide a second report of the parametric data associated with the print job to the print job aggregator after the print job has been completed.

### BACKGROUND

Printer devices are often used in network environments. Some print devices are more expensive and use more expensive consumables, for example, paper, ink, toner, etc. than others, and it may be desirable to monitor the costs of the use of such printer devices. For example, when several departments of a business have access to the same printer, one department may make greater use of a particular printer than others or may use more expensive consumables associated with a particular printer. In this respect, a business may wish to track the use of a printer by specific individuals and the corresponding costs of such use to properly allocate charges to appropriate departments.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram that illustrates a print auditing network, according to an embodiment of the present invention;

FIG. 2 is a block diagram of the example network of FIG. 1 illustrating the print auditing network components in data communication with one another, according to an embodiment of the invention;

FIG. 3 is a block diagram of one example of a client of the print auditing network of FIG. 1, according to an embodiment of the invention;

FIG. 4 is a block diagram of one example of a print server of the print auditing network of FIG. 1, according to an embodiment of the invention;

FIG. 5 is a block diagram of one example of a printer of the print auditing network of FIG. 1, according to an embodiment of the invention;

FIG. 6 is a flow chart that provides one example of a client agent executed in the client of FIG. 3, according to an embodiment of the invention;

FIG. 7 is a flow chart that provides one example of a print server agent executed in the print server of FIG. 4, according to an embodiment of the invention; and

FIG. 8 is a flow chart that provides one example of a printer agent executed in the printer of FIG. 5, according to an embodiment of the invention.

### DETAILED DESCRIPTION

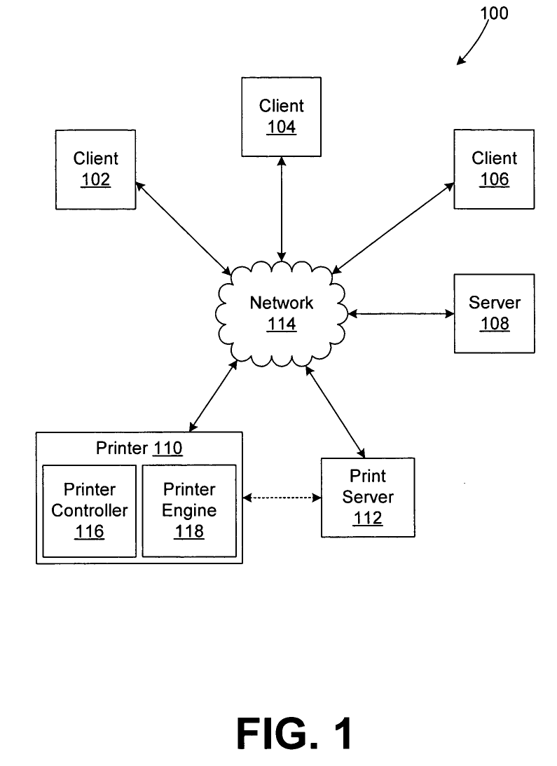

With reference to FIG. 1, shown is a print auditing network 100 according to an embodiment of the present invention. The print auditing network 100 includes at least one client, for example, clients 102, 104, 106, one or more servers, for example, server 108, one or more printers, for example printer 110, and a print server 112 associated with the printer 110. The client computers 102, 104, 106, the server 108, the printer 110, and the print server 112 are each coupled to each other through network 114 and are in data communication with each other. The print server 112 may be, for example, a computer system or other system with like capability. The print server 112 may include a large data storage capacity to accommodate several print jobs. Various print jobs from the clients, for example clients 102, 104, and 106, are spooled on print server 112 where they can be queued in the order of receipt, or in some alternative manner, before the print jobs are sent to the printer 110 for printing.

In an alternative embodiment, the client 102 can be a multifunctional peripheral (MFP) that digitally sends a print job to the server 108, which may store the print job or send the print job to the printer 110. In another embodiment, the printer 110 can be an image forming device that can be located on the same device as the client 102 and the print server 108, such as for example, in a multifunctional peripheral.

The printer 110 includes a printer controller 116 and a printer engine 118. The printer controller 116 controls the various functions of the printer hardware, such as motors, paper path moving equipment, equipment that generates images on print media, and that actually facilitate the printing of a document. The printer hardware may comprise a laser printing system, an ink jet printing system, a photocopying system or other appropriate hardware. The printer engine 118 attends to preprint functions such as raster image processing of documents into raster data that is provided to the printer controller 116 to drive the printing of the documents. The print server 112 may be coupled to the printer 110 through the network or through a direct connection such as through an appropriate cable, etc. The network 114 may include, for example, the Internet, intranets, wide area networks (WANs), local area networks (LANs), wireless networks, or other suitable networks, etc., or any combination of two or more such networks.

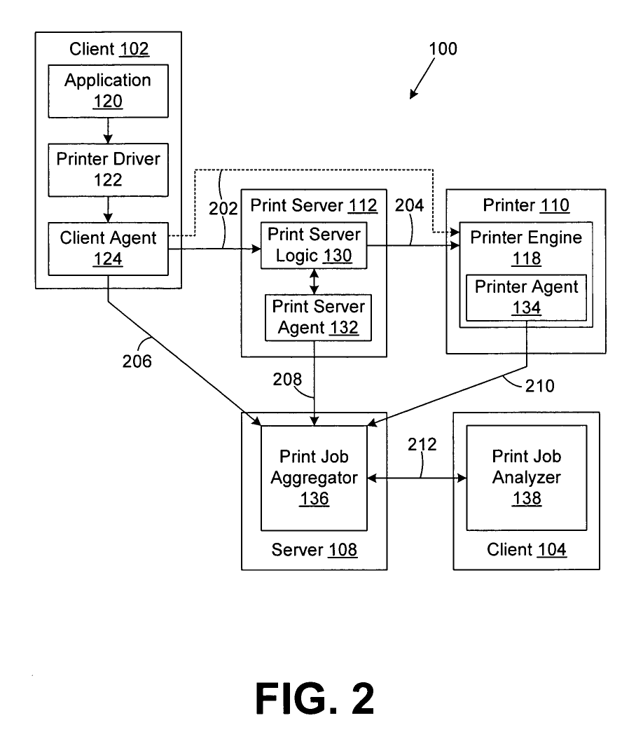

Referring next to FIG. 2, shown is a block diagram that illustrates the flow of information between the components of the print auditing network 100 that are in data communication with one another, according to an example embodiment of the present invention. Stored and executed in a client, for example client 102, are an application 120, a print driver 122, and a client agent 124. The application 120 may be, for example, a word processor or any other application that may be manipulated to create or access a document to be printed. The printer driver 122 is executed to interface with the printer 110 on behalf of the application 120, as can be appreciated.

Stored and executed in the print server 112, are print server logic 130 and a print server agent 132. Within the printer 110 is the printer engine 118 that includes a printer agent 134. Stored and executed in a server, for example server 108 is a print job aggregator 136. Stored and executed in a client, for example client 104, is a print job analyzer 138.

Next, a discussion of the operation of the various systems within the print auditing network 100 is provided, according to various embodiments of the present invention. Assume that a user wishes to print a document. In this respect, the user may manipulate the application 120 to create or access a document to be printed. The user manipulates the application 120 to initiate printing of the document. In this respect, the application 120 communicates with the printer driver 122 to create a print job. The print job includes both a document that is to be printed by printer 110 and parametric data associated with the document to be printed. As contemplated herein the term “document” refers to a collection of images and/or text on one or more pages embodied in the form of a digital file or expressed on a print medium. Parametric data is information within the print job about the document to be printed. Parametric data associated with a respective print job can be generated or altered within each component in the print auditing network 100, as will be further described. The parametric data can be included, for example, in a header associated with the print job, or the parametric data may be located in some other portion of the print job. The parametric data can also be included in a document that is associated with the print job, but transmitted independently through an out-of-band method that is not a part of the print job stream.

Upon the creation of the print job by the printer driver 122 and the application 120, the client agent 124 is executed to alter or add to the parametric data, as is deemed appropriate. In this respect, the client agent 124 is configured to add unique information to the parametric data about the print job that was not included by the printer driver 122 or the application 120. Also, the client agent 124 may be configured to alter the parametric data included in the print job by the application 120 or the printer driver 122. In this manner, the client agent 124 updates the parametric data before the print job is sent to either the print server 112 or directly to the printer 110. Parametric data associated with the print job by the client agent 124 may include a globally unique identifier, user information, logon information, print job name, the destination device, instructions as to how the print job is to be rendered, instructions for printing, network addressing information or other information, etc. The parametric data can also include print job information including print job size, file name, date, time, and information about the generating application or printer driver, or any attribute of the print job. In addition, the client agent 124 may gather information from the user about the print job, such as client code or matter identification.

After the client agent 124 updates the parametric data associated with the print job, the client agent makes a copy of the parametric data and transmits a report 206 of the parametric data to the print job aggregator 136 in the server 108. In some instances, the client agent 124 may not make any alterations to the parametric data. The client agent 124 then transmits the print job 202 to the print server 112. In another embodiment, the client agent 124 sends the print job 202 directly to the printer 110 where no print server 112 is employed with the printer 110 in the print auditing network 100.

As stated above, in one embodiment the client agent 124 determines whether the parametric data associated with each print job includes a globally unique identifier (GUID). If the parametric data does not include a globally unique identifier associated with it, the client agent 124 may generate a globally unique identifier that is guaranteed to be universally unique across the print auditing network 100. In this respect, the addition of the globally unique identifier is one way that the client agent 124 updates the parametric data of the print job. The algorithm for generating a globally unique identifier can include information about the client 102 such as, for example, a serial number or other information about the client 102. Once generated, the globally unique identifier remains unchanged by other agents, for example print server agent 132 and printer agent 134 in the print path, although other parametric data associated with the print job may be altered or added along the print path as will be discussed.

If a print server, such as print server 112, is present in the print auditing network 100, then the client agent 124 transmits the print job 202 directly to the print server 112. The print server agent 132 communicates with the print server logic 130, and to the extent that the print server 112 has unique information which can be added to the parametric data, or to the extent that the print server 112 can alter or change the parametric data associated with the print job, the print server agent 132 updates the parametric data before the print job is sent to the printer 110. The print server 112 then copies the parametric data and sends a report 208 of the parametric data to the print job aggregator 136 of server 108 before transmitting the print job 204 to the printer 110. Assuming the parametric data is embodied in a header in the print job, then the printer server agent 132 may copy the header and transmit the copy of the header to the server 108.

Parametric data that can be updated by the printer server 112 may include, for example, information about special page processing or other information. For example, the print server 112 may be configured to alter all print jobs to print in “duplex” where some print jobs may originally specify single-sided printing. Also, the print server 112 may include specific information about print cost or other parameters associated with the printing of the print job on the printer 110 and other printers on the print auditing network 100. In this respect, the print server 112 may direct the print job 204 to a printer other than printer 110. Also, the print server agent 132 may update the parametric data by adding information concerning the length of time the print job has been held in the queue, information as to whether a back-up copy has been made, the length of time the back-up will be retained, and any additional processing instructions such as “N-up”, “duplex”, and translation from one language, for example, Page Description Language (PDL), to another, etc.

Once the printer engine 118 of printer 110 receives the print job 204 from the print server 112, the printer agent 134 is executed to make a copy of the parametric data associated with the print job 204. The printer agent 134 communicates with the printer engine 118 during the printing of the document to update the parametric data with regard to the status of the print job. As the document is printed by printer 110, the printer agent 134 may be configured to add to or alter the parametric data. For example, the printer agent 134 may add or alter the parametric data as an indication as to the actual number of pages of the document that were printed by the printer 110. The printer agent 134 can also update the parametric data by recording information that is unique to the printer 110, such as, the use and cost of any consumables, for example, toner, ink, paper, or other consumables employed in the printing of the document . The printer agent 134 may also update “receive time”, “completion time”, “processing time”, as well as updated information concerning paper handling transactions such as “folded”, “stapled”, “punched”, “binding” etc. Upon completion of printing, the printer agent 134 sends a report 210 of the updated parametric data to the print job aggregator 136.

Thus, each of the agents 124, 132, and 134 along the print path will add appropriate parametric data to the print job or alter the parametric data as the print job progresses through the print auditing network. The client agent 124, the print server agent 132, and the printer agent 134 communicate with the print job aggregator 136 to share the parametric data at each location in the network 100. The communication of the reports 206, 208, 210 of the parametric data by the agents 124, 132, 134 to the print job aggregator 136 may occur independently or simultaneously when the parametric data is ready to be transmitted, such as, after a fixed number of print job headers have been collected, at predefined intervals, or as a reply to a request by the print job aggregator 136. The specific configuration implemented in this regard may take into account the amount of data traffic experienced in the network 100.

The print job aggregator 136 stores the parametric data, for example, in a database that may include predefined fields, etc. For example, the parametric data can be organized as one record entry database for each print job, or the parametric data can be placed into a single correlated record that includes several print jobs. The parametric data from the various components of the print auditing network 100 can be correlated and sorted according to the globally unique identifier. That is, the reports 206, 208, and 210 of the parametric data sent to the print job aggregator 136 by the client agent 124, the print server agent 132, and the printer agent 134 can all have the same globally unique identifier that ties the reports together. For example, the globally unique identifier can be used to correlate the actual number of pages printed on the printer 110, as reported by the printer agent 134, to an estimated number of pages reported by the client agent 124. Alternatively, the globally unique identifier may be employed to correlate other data from the parametric data received from the various agents 124, 132, 134 for a respective print job. In this respect, the client 102, the print server 112, and the printer 110 can all be considered parametric data producers because all can either alter or add to existing parametric data associated with a print job. The aggregator 136 can also selectively choose the parametric data to be correlated based on a set of either predefined or administrator defined policies.

Once the parametric data has been stored in the database, the parametric data can be accessed by the print job analyzer 138 of client 104. The print job analyzer 138 can create queries that access the parametric data associated with a print job so that, for example, the user can view various reports regarding print costs or other aspects of printing via appropriate tables, pie charts, or other manner of data presentation, etc. A business can independently collect parametric data associated with each component of the print auditing network 100, which can be helpful to monitor the use of interdepartmental printers 110.

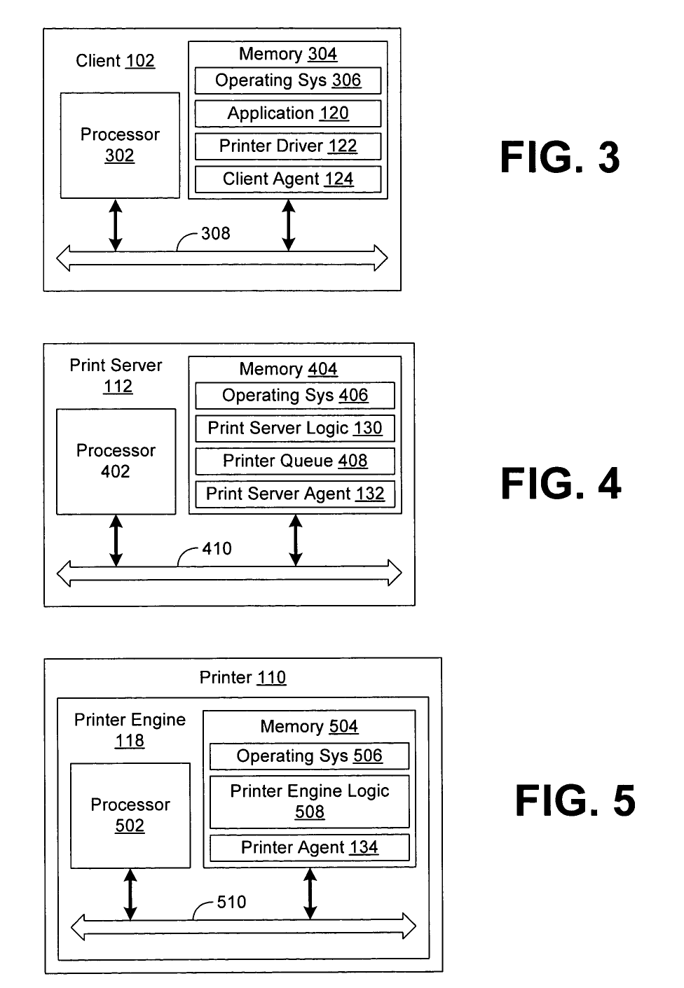

In FIGS. 3, 4, and 5 are shown block diagrams, for example, of the client 102, the print server 112, and the printer 110 shown in FIG. 2, according an embodiment of the invention. For purposes of the following discussion, first a general description of the hardware is described followed by the operation of the various components, according to the various embodiments of the present invention.

The client 102 of FIG. 3 may be, for example, a computer system, laptop, personal digital assistant, or other device with like capability. The client 102 includes a processor circuit having a processor 302 and a memory 304, both of which are coupled to a local interface 308. In this respect, the local interface 308 may be, for example, a data bus with an accompanying control/address bus as can be appreciated with those of ordinary skill in the art. Stored in the memory 304 and executable by the processor 302 are a number of software components such as, for example, an operating system 306, one or more applications 120, the printer driver 122, and the client agent 124. Alternatively, the client agent 124 may actually be a portion of the printer driver 122.

The client agent 124 is executed to update parametric data associated with the print job. As described above, the print job can include parametric data and a document to be printed in the printer 110 where the document can be embodied in the form of a digital file generated by an application 120 on the client 102 or which may be obtained from other source as can be appreciated by those with ordinary skill in the art. The client agent 124 updates the parametric data, by altering or adding parametric data to existing parametric data associated with the print job that may have been generated by the printer driver 122. If parametric data does not exist or only partially exists for the print job then the client agent 124 may create all or a portion of the parametric data associated with the print job.

Referring to FIG. 4, in some embodiments, the print auditing network 100 can optionally include a print server 112. The print server 112 may be, for example, a computer system or other device with like capability. In this respect, the print server 112 includes a processor circuit having a processor 402 and a memory 404, both of which are coupled to a local interface 410. The local interface 410 may be, for example, a data bus with accompanying control/address bus, as can be appreciated with those with ordinary skill in the art.

Stored in the memory 404 and executable by a processor 402 are a number of software components, such as, for example, an operating system 406, the print server logic 130, a printer queue 408, and the print server agent 132. The printer queue 408 is commonly known in print servers and is employed to temporarily store print jobs that are ultimately transmitted to the printer 110 (FIG. 1) for printing in a predefined order, etc. The print server agent 132 can update, that is to add to or alter, the parametric data associated with the print job 202 (FIG. 2) received from the client 102. The print server agent 132 also transmits a report of the updated parametric data to the print job aggregator 136 before the parametric data is transmitted to the printer 110, as described above.

The printer 110 of FIG. 5 may be a stand alone printer or may be included within the capabilities of an appropriate system such as, for example, a copier, multi-functional peripheral, or other image forming device. The printer 110 receives the print job from a client 102 or print server 112 and prints the document that is the subject of the print job. The printer 110 includes a processor circuit having a processor 502 and a memory 504, both of which are coupled to a local interface 510. The local interface 510 may comprise, for example, a data bus with an accompanying control/address bus, as can be appreciated by those with ordinary skill in the art.

Stored on the memory 504 and executable by the processor 502 are a number of software/firmware components including, for example, an operating system 506 and printer engine logic 508. The printer engine logic 508 is executed to perform various pre-print operations associated with the printing of a print job. The printer engine logic 508 also includes the printer agent 134. The printer agent 134 is executed to store and update parametric data associated with a print job received from the client 102 or print server 112. The printer agent 134 transmits the reports of the parametric data to the print job aggregator 136 as will be further described below.

As contemplated herein, the term “executable” means a program file that is in a form that can ultimately be run by a processor. Examples of executable programs may be, for example, a compiled program that can be translated into machine code in a format that can be loaded into a random access portion of a memory and run by a processor, or source code that may be expressed in proper format such as object code that is capable of being loaded into a random access portion of a memory and executed by a processor, etc. An executable program may be stored in any portion or component of a memory including, for example, random access memory, read-only memory, a hard drive, compact disk (CD), floppy disk, or other memory components.

In addition, each of the memories 304, 404, and 504 is defined herein as both volatile and nonvolatile memory and data storage components. Volatile components are those that do not retain data values upon loss of power. Nonvolatile components are those that retain data upon a loss of power. Thus, each of the memories 304, 404, and 504 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, although each of the memories 304, 404, and 504 are shown in close proximity to their respective processors 302, 402, and 502, respectively, the memories 304, 404, and 504, may be located remote to the processors 302, 402, and 502, and accessed, for example, via the network 114.

Also, each of the processors 302, 402, and 502 may represent multiple processors and each of the memories 304, 404, and 504 may represent multiple memories that operate in parallel processing circuits, respectively. In such a case, each of the local interfaces 308, 410, and 510 may be an appropriate network that facilitates communication between any two of the multiple processors, between any processor and any of the memories, or between any two of the memories, etc. The processors 302, 402, and 502 may be of electrical, optical, or molecular construction, or of some other construction as can be appreciated by those with ordinary skill in the art.

Each of the operating systems 306, 406, and 506 is executed to control the allocation and usage of hardware resources such as the memory, processing time, peripheral devices, and subsystems in the client 102, print server 112, and printer 110, respectively. In this manner, each of the operating systems 306, 406, and 506 serve as the foundation on which applications depend as is generally known by those with ordinary skill in the art.

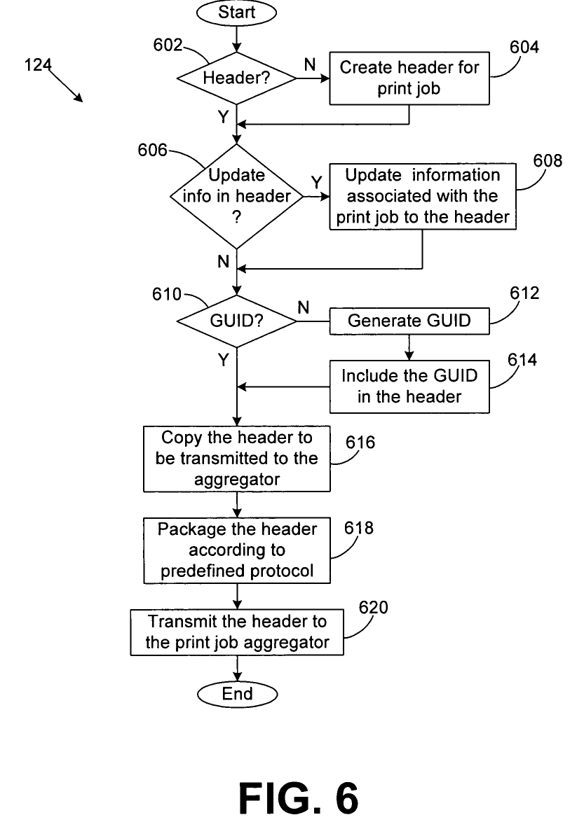

In FIGS. 6, 7, and 8 are flow charts that provide examples of the client agent 124, the print server agent 132, and the printer agent 134 (FIG. 2). The example embodiments described below with respect to FIGS. 6, 7, and 8 assume that the parametric data associated with the print job is included the header in the print job. However, it can be appreciated that the parametric data may be located elsewhere in the print job.

Referring next to FIG. 6 shown is a flow chart that provides one example of the operation of the client agent 124, according to an embodiment of the present invention. Alternatively, the flow chart of FIG. 6 may be viewed as depicting steps of an example of a method implemented in the client 102 (FIG. 1) to update the parametric data and to transmit a report of the parametric data to the print job aggregator 136 prior to transmitting the print job to the print server 112 or the printer 110. The functionality of the client agent 124, as depicted by the example flow chart of FIG. 6, may be implemented, for example, in an object or in a design or in some other programming architecture. Assuming the functionality is implemented in an object oriented design, then each block represents functionality that may be implemented in one or more methods that are encapsulated in one or more objects. The client agent 124 may be implemented using any one of a number of programming languages such as, for example, C, C++, Java, or other programming languages.

Beginning with box 602, the client agent 124 first determines whether a header that includes parametric data has been provided with the print job. If so, then the client agent 124 (FIG. 2) proceeds to box 606. If there has been no header or parametric data created for the print job, then at box 604 of client agent creates the header for the print job. Thereafter, the client agent 124 proceeds to box 606. At box 606, the client agent 124 determines whether there is any additional information for updating the header that is associated with the print job. Updated information can include additional parametric data that is to be created as a header or added to an existing header, or an altering of the existing parametric data that is already included in the header. Such parametric data may comprise, for example, a globally unique identifier, user information, logon information, print job name, the destination device, instructions for printing, network addressing information or other information, etc. Parametric data can also include print job information including print job size, file name, date, time, and information about the generating application or print driver. In addition, the client agent 124 may gather information from the user about the print job, such as client code or matter identification.

Next, in box 610, the client agent 124 determines whether a globally unique identifier (GUID) is associated with the print job. If so, then the client agent 124 proceeds to box 616. If no globally unique identifier is included in the header, then, at box 612, the client agent generates a globally unique identifier for the print job. Thereafter, at box 614, the client agent 124 adds the globally unique identifier to the parametric data in the header.

Next, in box 616, the client agent 124 makes a digital copy of the parametric data included in the header to be transmitted to the print job aggregator 136 (FIG. 1). In this manner, the client agent 124 may make a digital copy of the header itself. In box 618, the client agent 124 formats the parametric data into an appropriate message, according to a predefined protocol that can be received and understood by the print job aggregator 136. By generating the message that includes the parametric data, as described above, the client agent 124 generates a report of the parametric data that is to be transmitted to the print job aggregator 136 (FIG. 2). Finally, in box 620, the client agent 124 transmits the parametric data of the header to the print job aggregator 136. Thereafter, the client agent 124 ends as shown.

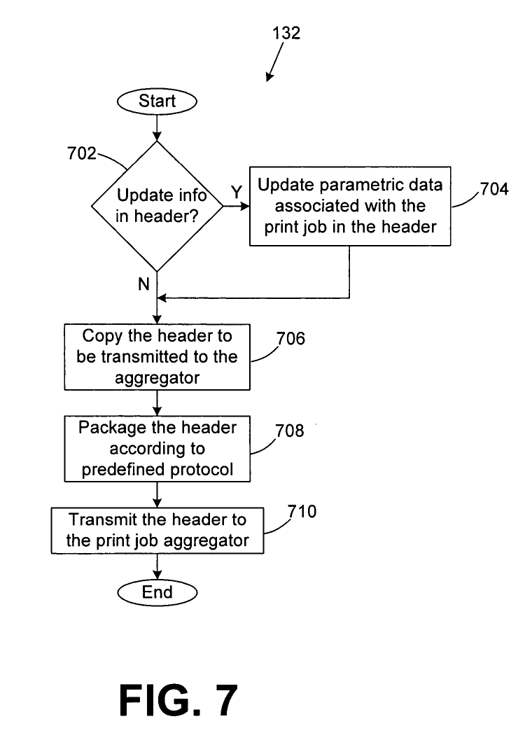

Referring next to FIG. 7, shown is a flow chart that provides one example of the operation of the print server agent 132 (FIG. 2), according to an embodiment of the present invention. Alternatively the flow chart of FIG. 7 may be viewed as depicting steps of an example of a method implemented in the printer 110 (FIG. 1) to update parametric data associated with the print job in the print server 112 (FIG. 2) and to transmit a report of the parametric data to the print job aggregator 136. The functionality of the print server agent 132, as depicted by the example flow chart of FIG. 7, may be implemented, for example, in an object-oriented design or in some other programming architecture. Assuming the functionality is implemented in an object-oriented design, then each block represents functionality that may be implemented in one or more methods that are encapsulated in one or more objects. The print server agent 132 may be implemented using any one of the number of programming languages such as, for example, C, C++, Java, or other programming languages.

Beginning with box 702, the print server agent 132 first identifies whether there is to be any additional updates regarding the parametric data associated with the print job. Examples of updates to the parametric data that may occur in the print server 112 can include mandatory print format changes such as print pricing, “N-up”, “duplex” printing, and translation from one language, for example, Page Description Language (PDL), to another. The print server agent 132 may also update the parametric data by adding information concerning the retention time the print job has been held in the queue, information as to whether a back-up copy has been made, the length of time the back-up will be retained, and any additional processing instructions. Assuming the parametric data is to be updated, the print server agent 132 proceeds to box 704. Otherwise, the print server agent 132 progresses to box 706. In box 704, the print server agent 132 adds to or alters the parametric data in the header of the print job. The print server agent 132 then proceeds to box 706.

In box 706, print server agent 132 makes a digital copy of the parametric data associated with the print job for transmission to the print job aggregator 136 (FIG. 2). In box 708, the print server agent packages or formats the parametric data as the payload of a message, according to the predefined protocol that can be received and recognized by the print job aggregator 136 (FIG. 2). In this respect, the print server agent 132 generates a report of the parametric data associated with the print job to send to the print job aggregator 136. Then, in box 710, the print server agent 132 transmits the report of the parametric data to the print job aggregator 136. Thereafter, the print server agent 132 ends as shown.

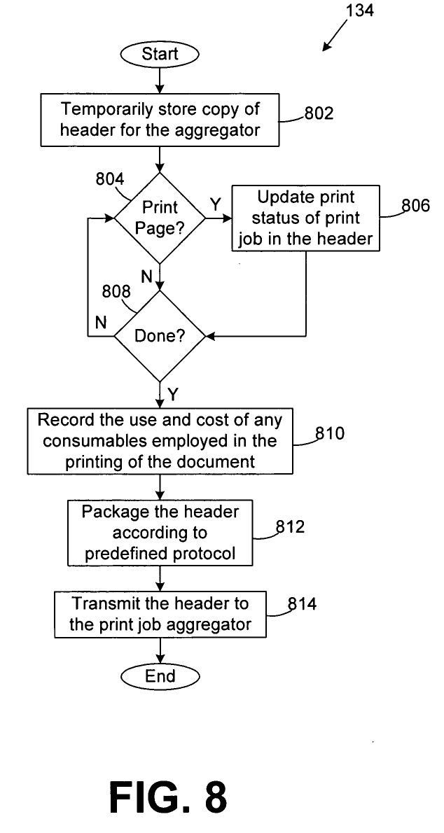

With reference to FIG. 8, shown is a flow chart that provides one example of the operation of the printer agent 134 (FIG. 2), according to an embodiment of the present invention. Alternatively the flow chart of FIG. 8 may be viewed as depicting steps of an example of a method implemented in the printer 110 to report parametric data to the print job aggregator 136 (FIG. 2). The functionality of the printer agent 134, as depicted by the example flow chart of FIG. 8, may be implemented, for example in an object-oriented design or in some other programming architecture. Assuming the functionality is implemented in an object-oriented design, then each block represents functionality that may be implemented in one or more methods that are encapsulated in one or more objects. Printer agent 134 may be implemented using any one of the number of programming language such as, for example, C, C++. Java, or other programming languages.

Beginning with box 802, the printer agent 134 temporarily stores a copy of the parametric data associated with the print job. In this respect, the printer agent 134 may store a copy of the header that may include the parametric data of the print job itself. In box 804, the printer agent determines whether a page of the document has been printed. If so, then the printer agent 134 proceeds to box 806. Otherwise, the printer agent 134 moves to box 808. In box 806, the printer agent 134 updates the print status of the print job in the header. Specifically, the number of pages printed is updated. Also, the consumables used in printing the page may be noted as well.

Next, in box 808, the printer agent 134 determines whether the printing has been completed in printer 110. Assuming the printer has not completed printing the document then, the printer agent 134 reverts back to box 804. If the printer has completed printing the document associated with the print job, then the printer agent 134 proceeds to box 810 where the printer agent 134 may record the use and cost of any consumables employed in the printing of the document. This information may be obtained, for example, from the printer 110. The printer agent 134 may also update “receive time”, “completion time”, “processing time”, as well as provide updated information concerning paper handling transactions such as “folded”, “stapled”, “punched”, “binding” etc. Next, in box 812, the printer agent packages the parametric data into an appropriate message, according to a predefined protocol such that the message will be received and recognized by the print job aggregator 136 (FIG. 2). In box 814, the printer agent transmits the parametric data to the print job aggregator 136. In this regard, the printer agent 134 transmits a report of the parametric data to the print job aggregator 136. Thereafter, the printer agent 134 ends as shown.

Although the agents 124, 132, 134, the print job aggregator 136, or the print job analyzer 138 are embodied in software or code executed by general purpose hardware as discussed above, as an alternative each may also be embodied in dedicated hardware or a combination of software/general purpose hardware and dedicated hardware. If embodied in dedicated hardware, the agents 124, 132, 134, the print job aggregator 136, and the print job analyzer 138 can each be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 6-8 show the architecture, functionality, and operation of an implementation of the agents 124, 132, and 134. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 6-8 show a specific order of execution, it is understood that the order of execution may differ from that which is depicted. For example, the order of execution of two or more blocks may be scrambled relative to the order shown. Also, two or more blocks shown in succession in FIGS. 6-8 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the agents 124, 132, 134, the print job aggregator 136, or the print job analyzer 138 comprise software or code, each can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the agents 124, 132, 134, the print job aggregator 136, or the print job analyzer 138 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

1. A print auditing network, comprising:
a client that originates a print job for printing, the print job including parametric data associated with the print job;
a printer in data communication with the client that is employed to print the print job, the print job being transmitted from the client to the printer;
a print job aggregator in data communication with the client and the printer;
a client agent executed in the client to provide a first report of the parametric data associated with the print job to the print job aggregator; and
a print agent executed in the printer to provide a second report of the parametric data associated with the print job to the print job aggregator, where the print job aggregator stores the first and second reports of the parametric data in a memory.

2. The print auditing network of claim 1, further comprising:
a print server in data communication with the client, the printer and the print job aggregator; and
a print server agent executed in the print server to provide a third report of the parametric data associated with the print job to the print job aggregator.

3. The print auditing network of claim 1, wherein the parametric data is included in a header associated with the print job.

4. The print auditing network of claim 2, wherein the parametric data is included in a header associated with the print job.

5. The print auditing network of claim 4, wherein a globally unique identifier is associated with each of the first, second, and third reports of the parametric data and the globally unique identifier is the same in the first, second and third reports.

6. The print auditing network of claim 4, wherein:
the client agent provides the first report of the parametric data to the print job aggregator by transmitting a copy of the header of the print job to the print job aggregator before the print job is transmitted from the client to the print server;
the print server agent provides the third report of the parametric data to the print job aggregator by transmitting a copy of the header to the print job aggregator before the print job is transmitted to the printer;
the printer agent provides the second report of the parametric data to the print job aggregator by transmitting the header to the print job aggregator after the print job is finished printing.

7. The print auditing network of claim 6, wherein:
the client agent is further configured to update the parametric data in the header of the print job;
the printer server is further configured to update the parametric data in the header of the print job; and
the printer agent is further configured to update the parametric data in the header of the print job.

8. A method for auditing a print job within a network, the method comprising:
originating a print job in a client to be printed;
associating parametric data with the print job, the parametric data describing the print job;
transmitting a first report of the parametric data from the client to a print job aggregator;
transmitting the print job from the client to a printer;
printing the print job in the printer; and
transmitting a second report of the parametric data from the printer to the print job aggregator after the print job is printed by the printer;

9. The method of claim 8, further comprising updating the parametric data of the print job in the printer during printing.

10. The method of claim 8, wherein transmitting the print job from the client to the printer further comprises:
transmitting the print job from the client to a print server that is in data communication with the client;
transmitting the print job from the print server to the printer that is in data communication with the print server; and
the method further comprising transmitting a third report of the parametric data from the print server to the print job aggregator.

11. The method of claim 10, further comprising including the parametric data in a header associated with the print job.

12. The method of claim 11, wherein the first report of parametric data, the second report of parametric data, and the third report of parametric data include the same globally unique identifier.

13. The method of claim 12, wherein:
the transmitting of the first report of the parametric data from the client to the print job aggregator further comprises transmitting a copy of the header of the print job from the client to the print job aggregator; and
the transmitting of the third report of the parametric data from the print server to the print job aggregator further comprises transmitting a copy of the header of the print job from the print server to the print job aggregator; and
the transmitting of the second report of the parametric data from the printer to the print job aggregator further comprises transmitting a copy of the header of the print job to the print job aggregator.

14. The method of claim 13, further comprises recording the use of consumables employed in the printing of a document of the print job prior to transmitting the second report of the parametric data to the print job aggregator.

15. A program embodied in a computer readable medium, comprising:
code that originates a print job in a client to be printed;
code that associates parametric data with the print job, the parametric data describing the print job; and
code that transmits a report of the parametric data from the client to a print job aggregator.

16. The program embodied in the computer readable medium of claim 15, further comprising code that associates the parametric data with a globally unique identifier.

17. The program embodied in the computer readable medium of claim 16, wherein the parametric data is included in a header associated with the print job.

18. The program embodied in the computer readable medium of claim 17, wherein a globally unique identifier is associated with the first report of the parametric data transmitted to the print job aggregator.

19. A program embodied in a computer readable medium, comprising:
code that identifies parametric data associated with a print job received from a client, the parametric data describing the print job;
code that updates the parametric data received from the client;
code that transmits a report of parametric data to a print job aggregator; and
code that transmits the print job to a printer.

20. The program embodied in the computer readable medium of claim 19, wherein the parametric data is included in a header associated with the print job.

21. The program embodied in the computer readable medium of claim 19, wherein a globally unique identifier is associated with the report of the parametric data transmitted to the print job aggregator.

22. A program embodied in a computer readable medium, comprising:
code that identifies parametric data associated with a print job, the parametric data describing the print job;
code that updates the parametric data that is subject to change based on a printing of the print job by the printer; and
code that transmits a report of parametric data from the printer to a print job aggregator after the print job is printed by the printer.

23. The program embodied in the computer readable medium of claim 22, wherein the parametric data is included in a header associated with the print job.

24. The program embodied in the computer readable medium of claim 22, wherein a globally unique identifier is associated with the report of the parametric data transmitted to the print job aggregator.

25. A print auditing network, comprising:
a client that originates a print job for printing, the print job including parametric data associated with the print job;
a printer in data communication with the client that is employed to print the print job, the print job being transmitted from the client to the printer;
a print job aggregator in data communication with the client and the printer;
means in the client for providing a first report of the parametric data associated with the print job to the print job aggregator; and
means in the printer for providing a second report of the parametric data associated with the print job to the print job aggregator, where the print job aggregator stores the first and second reports of the parametric data in a memory.

26. The print auditing network of claim 25, further comprising:
a print server in data communication with the client, the printer and the print job aggregator; and
means in the print server for providing a third report of the parametric data associated with the print job to the print job aggregator.

27. The print auditing network of claim 25, wherein the parametric data is included in a header associated with the print job.

28. The print auditing network of claim 26, wherein the parametric data is included in a header associated with the print job.

29. The print auditing network of claim 28, wherein a globally unique identifier is associated with each of the first, second, and third reports of the parametric data and the globally unique identifier is the same in the first, second and third reports.
